(19) United States
(12) Patent Application Publication
(10) Pub. No.: US 2022/0389242 A1
(43) Pub. Date: Dec. 8, 2022

(54) Filler for Wall Coatings

(71) Applicant: Amberger Kaolinwerke Eduard Kick GmbH & Co. KG, Hirschau (DE)

(72) Inventors: Angela Hullin, Erlangen (DE); Hans-Jürgen Hofmann, Rottendorf (DE); Christian Kohl, Amberg (DE)

(73) Assignee: Amberger Kaolinwerke Eduard Kick GmbH & Co. KG, Hirschau (DE)

(21) Appl. No.: 17/680,014

(22) Filed: Feb. 24, 2022

(30) Foreign Application Priority Data
Feb. 24, 2021 (EP) 21158930.4

(51) Int. Cl. C09D 7/61; C09D 7/40

(52) U.S. Cl. CPC C09D 7/61; C09D 7/69

(57) ABSTRACT

A filler for wall coating compositions, wherein said filler consists of particles, wherein said particles are fired mixtures of
40 to 70% by weight of clay minerals
5 to 32% by weight of crystalline silicic acids
10 to 45% by weight of feldspar
0 to 20% by weight of other aggregates,
   and wherein said particles have a d50 grain size of from 1 μm to 40 μm.

This application claims priority benefit from European Patent Application No. 21158930.4, filed on Feb. 24, 2021, the entire content of which is incorporated herein by reference. All references cited anywhere in this specification are incorporated by reference as if each had been individually incorporated.

The present invention relates to a filler for wall coating compositions, a process for preparing said filler for wall coating compositions, wall coating compositions comprising said filler, and a process for producing a wall coating composition.

In order to increase whiteness and opacity, calcined kaolins are employed in many cases in wall coating compositions or wall paints.

EP 1 715 009 A2 discloses the use of calcined kaolin as a filler for increasing the whiteness and opacity of white or colored surface coatings.

WO 2013/025444 A2 discloses a filler for wall coating compositions that comprises a calcined kaolin and preferably fluxes. The fluxes are added to said kaolin in order to lower the calcination temperature. The fillers produced have a positive influence on the wet abrasion resistance of wall coatings.

WO 2016/001303 A1 discloses particles that are fired mixtures of clay minerals, crystalline silicic acids, feldspar, and optionally other aggregates, and have a particle size (d50 grain size) within a range of from 0.1 to 3 mm. These particles are used in roof coatings.

US 2013/045384 describes a kaolin-based filler. Thus, kaolin is fired in order to achieve a mullite index of at least 25, preferably 25 to 62. The addition of fluxes is described.

A drawback in the calcination of kaolin is the fact this is done at about 1380° C. This requires a large amount of energy. In addition, calcined kaolin has a high oil number. The higher the oil number of a filler, the more binder a wall coating composition or wall paint has to contain. A higher demand for binder increases the cost and reduces the freedom in the addition of further additives to the wall coating compositions. In addition, a higher oil number may have a negative effect on the wet abrasion resistance of the wall coatings.

Thus, there is a need for further fillers for wall coating compositions.

Therefore, it has been the object of the present invention to provide a filler for wall coating compositions, a process for the preparation thereof, a wall coating composition comprising said filler, a process for producing such a wall coating composition, and uses of the filler for wall coating compositions, which overcome at least part of the problems known from the prior art.

The object of the invention is achieved by a filler for wall coating compositions, wherein said filler consists of particles, wherein said particles are fired mixtures of
40 to 70% by weight of clay minerals,
0 to 32% by weight, preferably 5 to 32% by weight, of crystalline silicic acids,
10 to 45% by weight of feldspar,
0 to 20% by weight of other aggregates,
   and wherein said particles have a d50 grain size of from 1 μm to 40 μm.

The filler for wall coating compositions consists of particles having a defined d50 grain size of from 1 μm to 40 μm. The particles are fired mixtures. For preparing the particles, mixtures of the described composition are made, sintered by firing, and subsequently ground to a defined grain size. The filler may be in the form of a powder.

In a preferred embodiment, the filler consists of particles that include fired mixtures of
40 to 70% by weight of clay minerals,
5 to 30% by weight of crystalline silicic acids,
10 to 30% by weight of feldspar,
0 to 20% by weight of other aggregates,
   wherein said particles have a d50 grain size of from 1 μm to 40 μm.

The addition of crystalline silicic acid presumably causes an increase of the fraction of amorphous phase by the formation of a glass. It seems that the addition of crystalline silicic acid thereby specifically reduces the oil number of the particles as compared to particles that do not contain any crystalline silicic acid.

Preferably, the particles have a d50 grain size of from 3 μm to 40 μm, more preferably from 3 μm to 30 μm, even more preferably from 3 μm to 25 μm.

In another embodiment according to the invention, the particles have a d50 grain size of from 4 μm to 15 μm.

“d50 grain size” means the grain size at which 50% by weight of the particles have a larger grain size, and 50% by weight have a smaller grain size. Such grain size distributions can be determined simply according to ISO 13320:2020-01 “Particle size analysis—Laser diffraction methods”. For example, the d50 value can be measured by using a laser granulometer from the manufacturer CILAS, model 1180, which meets this standard.

Preferably, said clay minerals are selected from the group consisting of kaolin, dickite, nacrite, halloysite, vermiculite, and mixtures thereof. Other minerals from the group of phyllosilicates are also suitable.

Preferably, the quantity of the clay minerals in the mixture to be fired is 45% by weight or more. Preferably, the quantity of the clay minerals is 65% by weight or less, more preferably 60% by weight or less.

In a preferred embodiment, a clay mineral is used that has a low total content of lead. Preferably, the clay mineral contains less than 300 ppmw, more preferably less than 200 ppmw, even more preferably less than 150 ppmw, of lead, respectively measured by means of X-ray fluorescence analysis according to DIN 51001:2003-08.

In another preferred embodiment, a clay mineral is used that additionally has a low content of iron, especially less than 1% by weight, based on the clay minerals, more preferably less than 0.5% by weight, based on the clay minerals. The iron content is measured by means of X-ray fluorescence analysis according to DIN 51001:2003-08 as Fe₂O₃.

Preferably, the crystalline silicic acids are selected from the group consisting of quartz, cristobalite, tridymite, and mixtures thereof. In addition, further minerals of the quartz group, such as coesite or opal, are suitable. The use of quartz is particularly preferred. Preferably, the proportion of quartz in the crystalline silicic acids is at least 50% by weight.

Preferably, the quantity of crystalline silicic acids is 1% by weight or more, 5% by weight or more, or 9% by weight or more. Preferably, the quantity of crystalline silicic acids is 30% by weight or less, 25% by weight or less, or 18% by weight or less.

In a preferred embodiment, a crystalline silicic acid is used that has a low total content of lead. Preferably, the crystalline silicic acid contains less than 300 ppmw of lead, as measured by means of X-ray fluorescence analysis according to DIN 51001:2003-08.

Preferably, the quantity of feldspar is 15% by weight or more, 20% by weight or more, or 25% by weight or more. Preferably, the quantity of feldspar is 40% by weight or less, 30% by weight or less, or 28% by weight or less.

Preferably, the feldspar employed has a low total content of lead. Preferably, the feldspar contains less than 300 ppmw of lead, as measured by means of X-ray fluorescence analysis according to DIN 51001:2003-08.

Preferably, the other aggregates are selected from the group consisting of alumina (Al₂O₃), tectosilicates that are not feldspars, phyllosilicates that are not clay minerals, silicates that are not tecto- or phyllosilicates, carbonates, and mixtures thereof.

Preferably, the quantity of other aggregates is at least 1% by weight. Preferably, the quantity of other aggregates is 10% by weight or less.

Preferably, the other aggregates contain less than 300 ppmw of lead, as measured by means of X-ray fluorescence analysis according to DIN 51001:2003-08.

Preferably, the filler for wall coating compositions according to the invention has at least one of the following properties:
i) a lead content of less than 300 ppmw, preferably less than 200 ppmw, respectively measured by means of X-ray fluorescence analysis according to DIN 51001:2003-08,
ii) an amorphous fraction of more than 10%, preferably more than 12%, more preferably 15% or more, respectively measured by means of X-ray diffraction followed by Rietveld refinement,
iii) an oil number of less than 80 g/100 g, preferably 50 g/100 g or less, more preferably 48 g/100 g or less, respectively measured according to DIN EN ISO 787-5:1995-10,
iv) a solar reflection across the total spectrum of at least 85%, measured according to ASTM Standard C 1549-16,
v) a solar reflection in the UV range of at least 78%, preferably 79% or more, respectively measured according to ASTM Standard C 1549-16,
vi) a softening temperature of less than 1720° C., measured according to DIN 51730:2007-09,
vii) a hemisphere temperature of less than 1740° C., measured according to DIN 51730:2007-09.

The filler according to the invention may have one, two, three, four, five, six or seven of the above mentioned properties i) to vii) independently of one another.

A low lead content has the advantage that the use of the fillers in wall coating compositions is safe in terms of health hazards. Conventional calcined kaolin often has a lead content of clearly more than 300 ppmw.

The oil number was determined according to DIN EN ISO 787-5:1995-10. According to DIN EN ISO 787-5:1995-10, the oil number is the quantity of refined linseed oil that is absorbed by a pigment or filler sample under predetermined conditions. The higher the oil number of the pigment or filler sample, the more binder a wall coating composition or wall paint has to contain. Therefore, a low oil number has the advantage that the binder requirement of a wall coating composition decreases. This reduces the cost of manufacture of the wall coating composition and enables further additives to be added. In addition, a low oil number has a positive effect on the wet abrasion resistance of the wall coatings.

For a filler for wall coating compositions, a high solar reflectivity over the entire spectrum can be an advantage. If the filler is used for facade paints, incident solar radiation is reflected. This avoids heating of the environment. Thus, so-called “urban heat islands” can be avoided. In addition, buildings are heated to a lesser extent by the solar radiation, so that cost savings in air conditioning can be achieved. More preferably, the filler for wall coating compositions has a high solar reflectivity in the UV range. Solar irradiation in the UV range can attack and destroy the binder for facade paint. Therefore, the use of fillers having a high solar reflectivity in the UV range can lead to an increase in the UV stability of the wall coating composition.

The solar reflection over the entire spectrum and the solar reflection in the UV range are determined according to ASTM Standard C 1549-16 (“standard test method for determination of solar reflection near ambient temperature using a portable solar reflectometer”). The “Solar Spectrum Reflectometer” Model SSR of the company Devices and Services, Dallas, Tex., USA, can be used as a measuring device.

The invention also relates to a process for producing a filler for wall coating compositions, wherein said filler consists of particles, comprising:
a) firing a mixture of
   40 to 70% by weight of clay minerals,
   0 to 32% by weight, preferably 5 to 32% by weight, of crystalline silicic acids,
   10 to 45% by weight of feldspar,
   0 to 20% by weight of other aggregates,
b) crushing the fired mixture,
c) grinding the crushed fired mixture to particles, wherein said particles have a d50 grain size of from 1 μm to 40 μm.

According to the invention, said firing of the mixture can be effected at temperatures of more than 1100° C. The mixtures may be fired at temperatures of about 1200° C., while the calcination of kaolin takes place at about 1380° C. This brings about a significant energy saving.

During the crushing in step b) of the process according to the invention, the mixture pressed into a pellet and fired is comminuted using suitable crushers.

Subsequently, the grinding of the crushed fired mixture to particles is effected in step c) of the process according to the invention, wherein said particles have a d50 grain size of from 1 μm to 40 μm. Said grinding is effected by using suitable mills. Preferably, these mills are ball mills, roller mills, pin mills, vibration mills, or air separation mills.

The invention further relates to a wall coating composition comprising said filler according to the invention.

Said wall coating composition may be plasters for houses or wall paints. Said wall paints are preferably dispersion, synthetic resin dispersion, acrylate, silicate, silicone, or dispersion acrylate paints, which can be used as both interior and outdoor or facade paints. Preferably, said wall coating composition is an aqueous dispersion paint, or an aqueous synthetic resin dispersion paint.

Preferably, said filler is contained in the wall coating composition in an amount of from 2 to 25% by weight, more preferably from 3 to 20% by weight, even more preferably from 5 to 15% by weight, still more preferably from 8 to 12% by weight.

Preferably, said wall coating composition additionally comprises at least one binder.

Preferably, said at least one binder is an organic binder, a silicate binder, or mixtures of organic and silicate binders. Preferably, said organic binder is a binder selected from the group consisting of poly(vinyl acetate), acrylate, vinyl acetate-ethylene copolymers, styrene-acrylate copolymers, and mixtures thereof. Preferably, said silicate binder is a binder selected from the group consisting of sodium water glass, potassium water glass, lithium water glass, and mixtures thereof.

Preferably, said at least one binder is contained in the wall coating composition in an amount of from 8% by weight to 16% by weight.

The wall coating composition according to the invention may additionally comprise other additives, such as pigments, dispersants, thickeners, pigment stabilizers, or biocides. Suitable additives are known to those skilled in the art.

The invention further relates to a process for producing a wall coating composition, comprising:
mixing the filler according to the invention with at least one binder.

The invention also relates to the use of particles that are fired mixtures of
40 to 70% by weight of clay minerals
0 to 32% by weight, preferably 5 to 32% by weight, of crystalline silicic acids
10 to 45% by weight of feldspar
0 to 20% by weight of other aggregates,
   and have a d50 grain size of from 1 μm to 40 μm, to increase the wet abrasion resistance of wall coatings.

The particles are the fillers according to the invention.

The wet abrasion resistance describes the wash or scrub resistance of finally cured and dried wall coatings. It is a measure of the resistance of a wall coating against mechanical abrasion, as may occur, for example, when a surface coated with said wall coating is being cleaned. The measurement of the wet abrasion resistance is effected according to DIN EN ISO 11998:2006-10. The mean loss of layer thickness is stated as the wet abrasion. The wet abrasion resistance can be determined by using a wash abrasion and scrub test device, as is commercially available, for example, from the company Erichsen GmbH & Co. KG under the designation Model 494 MC.

Surprisingly, it has been found that wall coatings having very good wet abrasion resistance values could be obtained using the fillers according to the invention. It is assumed that the low oil number of the fillers according to the invention has the effect that the wet abrasion resistance of the wall coatings containing said fillers is increased.

The invention also relates to the use of particles that are fired mixtures of
40 to 70% by weight of clay minerals
0 to 32% by weight, preferably 5 to 32% by weight, of crystalline silicic acids
10 to 45% by weight of feldspar
0 to 20% by weight of other aggregates,
   and have a d50 grain size of from 1 μm to 40 μm, in wall coating compositions for reducing the amount of binder used in wall coating compositions.

The particles are the fillers according to the invention.

Surprisingly, it has been found that the use of the fillers according to the invention in wall coating compositions has the result that the amount of binder used in the wall coating composition can be reduced. This is because the fillers have a low oil number.

The invention is further illustrated by means of the following Examples.

### EXAMPLE 1: PREPARATION OF FILLERS

Articles having the following composition were prepared by firing in an oxidizing atmosphere at 1200° C.:
60% by weight of kaolin
21% by weight of quartz
19% by weight of feldspar

These articles were subsequently crushed to a d50 grain size of approximately 1 mm.

Then, the crushed articles were ground. The following d50 grain sizes were obtained:

| Sample 1 | Sample 2 | Sample 3 |
|---|---|---|
| 3.3 μm | 5.4 μm | 11.8 μm |

Commercially available calcined kaolin (china clay) (DORKAFILL® H, Gebrüder Dorfner GmbH & Co. Kaolin- und Kristallquarzsandwerke KG, Hirschau, Germany) was used as a comparative sample in Examples 2, 3, 4, 7 und 8. It had a d50 grain size of 11.6 μm as measured with a CILAS laser granulometer. It has a mullite index of 45.

### EXAMPLE 2: OIL NUMBER

The oil number of the samples was determined according to DIN EN ISO 787-5:1995-10. The following oil numbers were measured:

| | | | Comparative |
|---|---|---|---|
| Sample 1 | Sample 2 | Sample 3 | sample |
| 47 g/100 g | 41 g/100 g | 35 g/100 g | 80 g/100 g |

Samples 1 to 3 according to the invention has essentially lower oil numbers than those of the comparative sample. Wall coating compositions prepared by using samples 1 to 3 therefore had a lower need for a binder as compared to wall coating compositions in which the calcined kaolin was used.

### EXAMPLE 3: LEAD CONTENT

The lead content of the samples was determined by means of X-ray fluorescence analysis according to DIN 51001:2003-08. The following lead contents were measured:

| | | | Comparative |
|---|---|---|---|
| Sample 1 | Sample 2 | Sample 3 | sample |
| <150 ppmw | <150 ppmw | <150 ppmw | 1200 ppmw |

Because of the low lead contents, the fillers according to the invention (samples 1 to 3) are safe in terms of health hazards. In contrast to the comparative sample, the use of the fillers according to the invention in wall coatings is possible without any problem.

### EXAMPLE 4: SOLAR REFLECTION

The total solar reflection for an angle of incidence of 20° with the perpendicular line was measured by using a “Solar Spectrum Reflectometer” Model SSR of the company Devices and Services, Dallas, Tex., USA. For this purpose, a representative and sufficiently large partial quantity of the sample to be measured was removed. A sample pan having a diameter of 55 mm was filled with the sample up to a level of 10 mm, the surface was smoothened using a spatula. The solar reflection value is stated as a mean of five measurements. The solar reflection over the entire spectrum and the solar reflection in the UV range (UV reflection) were determined. The particles had the following properties:

| | | | | Comparative |
|---|---|---|---|---|
| | Sample 1 | Sample 2 | Sample 3 | sample |
| Solar reflection | 92.5% | 91.4% | 91.9% | 92.5% |
| (entire spectrum) | | | | |
| UV reflection | 83.1% | 81.0% | 79.5% | 77.2% |

The fillers according to the invention (samples 1 to 3) had an increased solar reflection in the high energy UV range as compared to the comparative sample. Facade paints in which the fillers according to the invention are used are capable of reflecting incident solar radiation in the UV range very well.

### EXAMPLE 5: SOFTENING AND HEMISPHERE TEMPERATURE

The melting behavior of the samples on a hot stage microscope was examined. According to DIN 51730:2007-09, a specimen molded into a cube was heated, and its deformation was recorded by an imaging method. During the melting, characteristic points (softening temperature, hemisphere temperature, flow temperature) can be described. A hot stage microscope from Linseis was used. The samples had the following properties:

| | |
|---|---|
| Samples 1, 2 and 3 | Comparative sample* |

| | | | | |
|---|---|---|---|---|
| Softening | 1695° | C. | 1737° | C. |
| temperature | | | | |
| Hemisphere | 1720° | C. | >1740° | C. |
| temperature | | | | |
| Flow temperature | >1740° | C. | >1740° | C. |

*Calcined kaolin (AS 45 from the company Amberger Kaolinwerke Eduard Kick GmbH & Co. KG)

### EXAMPLE 6: AMORPHOUS FRACTION

The amorphous fraction of the samples was determined by X-ray diffraction followed by Rietveld refinement. Thus, the samples were ground fine, followed by making records with an X-ray diffractometer (Malvern-Panalytical EMPYREAN).

From these records, the mineral inventory was determined. In another step, 10% by weight of rutile was added to each sample, in order to determine also the amorphous fraction of each sample in addition to the crystalline components by a Rietveld analysis. The samples had the following amorphous fraction:

| Samples 1, 2 and 3 | Comparative sample* |
|---|---|
| 16% | 9% |

*Calcined kaolin (AS 45 from the company Amberger Kaolinwerke Eduard Kick GmbH & Co. KG)

### EXAMPLE 7: WALL COATING COMPOSITION

An aqueous dispersion paint having a pigment volume concentration of 80% was prepared. It had the following composition:

| Component | % by weight |
|---|---|
| Water | 30.1 |
| Calgon N | 0.05 |
| BYK 155/35 | 0.9 |
| BYK 014 | 0.2 |
| Acticide MBS | 0.1 |
| Walocell XM 6000 PV | 0.5 |
| Walocel XM 30.000 PV | 0.1 |
| Kronos 2300 | 10 |
| CaCO₃ Omyacarb 2 | 38 |
| Sample 1, 2, 3 or comparative sample | 10 |
| Mowilith LDM 1871 | 10 |
| BYK 014 | 0.2 |
| Acrysol RM 8 W | 0.1 |
| Total | 100.0 |

### EXAMPLE 8: WET ABRASION RESISTANCE

In order to determine the wet abrasion resistance of the wall coating, the deaerated spreadable paints from Example 7 (containing either one of samples 1, 2 or 3 or commercially available calcined kaolin (DORKAFILL® H, Gebrüder Dorfner GmbH & Co. Kaolin- and Kristallquarzsandwerke KG, Hirschau) as a filler) were applied to a black-and-white paint card (company Erichsen GmbH & Co. KG) with a film thickness of 200 μm using a film applicator (product Zehntner, type ZAA 2300) using a doctor blade. After the doctor blade coating, they were dried for two weeks according to standard DIN EN ISO 11998:2006-10. The measurement of the wet abrasion resistance was effected according to DIN EN ISO 11998:2006-10, in which the surface to be tested is loaded with a defined number of cycles. The mean loss of layer thickness is stated as the wet abrasion. The wet abrasion resistance was determined with a wash abrasion and scrub test device model 494 MC of the company Erichsen GmbH & Co. KG. The following values for the wet abrasion were determined:

| | | | Comparative |
|---|---|---|---|
| Sample 1 | Sample 2 | Sample 3 | sample |
| 45.3 μm | 30.8 μm | 14.9 μm | 32.1 μm |

The fillers according to the invention (samples 1 to 3) allowed for the production of wall paints having very good wet abrasion resistance values. Excellent values could be achieved with particles of samples 2 and 3.

1. A filler for wall coating compositions, wherein said filler consists of particles, wherein said particles are fired mixtures of
40 to 70% by weight of clay minerals
5 to 32% by weight of crystalline silicic acids
10 to 45% by weight of feldspar
0 to 20% by weight of other aggregates,
and wherein said particles have a d50 grain size of from 1 μm to 40 μm.

2. The filler according to claim 1, wherein said particles are fired mixtures of
40 to 70% by weight of clay minerals
5 to 30% by weight of crystalline silicic acids
10 to 30% by weight of feldspar
0 to 20% by weight of other aggregates.

3. The filler according to claim 1, wherein the particles have a d50 grain size of from 3 μm to 40 μm.

4. The filler according to claim 1, wherein said clay minerals are selected from the group consisting of kaolin, dickite, nacrite, halloysite, vermiculite, and mixtures thereof.

5. The filler according to claim 1, wherein the crystalline silicic acids are selected from the group consisting of quartz, cristobalite, tridymite, and mixtures thereof.

6. The filler according to claim 1, wherein the other aggregates are selected from the group consisting of alumina (Al₂O₃), tectosilicates that are not feldspars, phyllosilicates that are not clay minerals, silicates that are not tecto- or phyllosilicates, carbonates, and mixtures thereof.

7. The filler according to claim 1, wherein said filler has a lead content of less than 300 ppmw, preferably less than 200 ppmw, respectively measured by means of X-ray fluorescence analysis according to DIN 51001:2003-08, and/or an amorphous fraction of more than 10%, as measured by means of X-ray diffraction followed by Rietveld refinement.

8. The filler according to claim 1, wherein said filler has an oil number of less than 80 g/100 g, preferably 50 g/100 g or less, respectively measured according to DIN EN ISO 787-5:1995-10, and/or a solar reflection across the total spectrum of at least 85%, measured according to ASTM Standard C 1549-16.

9. The filler according to claim 1, wherein said filler has a softening temperature of less than 1720° C., measured according to DIN 51730:2007-09, a hemisphere temperature of less than 1740° C., measured according to DIN 51730:2007-09 or both.

10. A wall coating composition, comprising the filler according to claim 1 and at least one binder.

11. The wall coating composition according to claim 10, wherein said filler is contained therein in an amount of from 2 to 25% by weight.

12. A process for producing a filler for wall coating compositions, wherein said filler consists of particles, comprising:
a) firing a mixture of
40 to 70% by weight of clay minerals
5 to 32% by weight of crystalline silicic acids
10 to 45% by weight of feldspar
0 to 20% by weight of other aggregates;
b) crushing the fired mixture,
c) grinding the crushed fired mixture to particles, wherein said particles have a d50 grain size of from 1 μm to 40 μm.

13. A process for producing a wall coating composition, comprising:
mixing the filler according to claim 1 with at least one binder.

14. A method of increasing the wet abrasion resistance of wall coatings, comprising adding particles that are fired mixtures of
40 to 70% by weight of clay minerals
5 to 32% by weight of crystalline silicic acids
10 to 45% by weight of feldspar
0 to 20% by weight of other aggregates,
and have a d50 grain size of from 1 μm to 40 μm, into a wall coating composition.

15. A method of reducing the amount of binder used in wall coating compositions comprising adding particles that are fired mixtures of
40 to 70% by weight of clay minerals
5 to 32% by weight of crystalline silicic acids
10 to 45% by weight of feldspar
0 to 20% by weight of other aggregates,
and have a d50 grain size of from 1 μm to 40 μm, into a wall coating composition having a reduced amount of binder.
